(19) United States
(12) Patent Application Publication
(10) Pub. No.: US 2018/0013610 A1
(43) Pub. Date: Jan. 11, 2018

(54) FILE DELIVERY METHOD, APPARATUS AND SYSTEM

(71) Applicant: TENCENT TECHNOLOGY (SHENZHEN) COMPANY LIMITED, Shenzhen (CN)

(72) Inventors: Kun SHEN, Shenzhen (CN); Qiang LIU, Shenzhen (CN)

(21) Appl. No.: 15/712,419

(22) Filed: Sep. 22, 2017

Related U.S. Application Data
(63) Continuation of application No. PCT/CN2016/078481, filed on Apr. 5, 2016.

(30) Foreign Application Priority Data
Aug. 12, 2015 (CN) 201510492909.8

(51) Int. Cl. H04L 29/08; G06F 17/30

(52) U.S. Cl. CPC H04L 29/08468; G06F 17/30067; H04L 67/1078

(57) ABSTRACT

The present disclosure provides a file delivery method. The file delivery method includes receiving a task request for a file delivery task sent by a target node to request a file; determining according to the task request whether there are completed nodes, the completed nodes being other target nodes that have completed a file delivery task delivering the file; designating, if there are completed nodes, a node from the completed nodes as a source station corresponding to the task request; designating, if there are no completed nodes, a source server as the source station corresponding to the task request; and delivering the file to the target node through the designated source station.

### RELATED APPLICATION

This application claims priority to PCT Application No. PCT/CN2016/078481, filed on Apr. 5, 2016, which claims priority to Chinese Patent Application No. 2015104929098, entitled “FILE DELIVERY METHOD, APPARATUS AND SYSTEM” filed on Aug. 12, 2015. Both applications are herein incorporated by reference in the entirety.

### FIELD OF THE TECHNOLOGY

The present disclosure relates to the field of communications technologies, and in particular, to a file delivery method, apparatus and system.

### BACKGROUND OF THE DISCLOSURE

A Content Delivery Network (CDN) is a well accepted file delivery technology in recent years. Its basic principle to use various types of cache servers based on global load management techniques, by distributing the cache servers to regions or networks where user accesses are relatively centralized, and when a user accesses a website, directing the user to a closest cache server operating normally, and directly responding, by the cache server, to the user request. The cache servers are equivalent to source stations, also referred to as source servers. When large files are delivered, a Hypertext Transfer Protocol (HTTP), remote sync (r-sync or remote sync) protocol, and even some private protocols are generally used. The files are delivered to target nodes directly from the source servers.

However, when there are more target nodes, the source server may have a heavy load, which may lead to reduction of stability of the source server and the throughput of the source server, causing a slower delivery speed.

### SUMMARY

Embodiments of the present disclosure provide a file delivery method, apparatus and system, which can reduce the load of a source server, improve stability of the source server, and increase the delivery speed.

The present disclosure provides a file delivery method. The file delivery method includes receiving a task request for a file delivery task sent by a target node to request a file; determining according to the task request whether there are completed nodes, the completed nodes being other target nodes that have completed a file delivery task delivering the file; designating, if there are completed nodes, a node from the completed nodes as a source station corresponding to the task request; designating, if there are no completed nodes, a source server as the source station corresponding to the task request; and delivering the file to the target node through the designated source station.

Another aspect of the present disclosure provides another file delivery method. The method includes sending a task request for a file delivery task to a task management system; receiving the file delivery task returned by the task management system according to the task request; acquiring a file from a source station according to the file delivery task, and storing the file; and reporting to the task management system a task execution result indicating that file acquisition is successful.

Another aspect of the present disclosure provides a task management and delivery system including a storage medium, storing a processor executable instruction therein, the processor executable instruction being used for performing the following operations. The operations include receiving a task request for a file delivery task for delivering a file sent by a target node; determining according to the task request whether there are completed nodes, the completed nodes being other target nodes that have completed a file delivery task delivering the file; designating, if the determination unit determines that there are completed nodes, a node from the completed nodes as a source station corresponding to the task request, and designate, if the determination unit determines that there are no completed nodes, a source server as the source station corresponding to the task request; and delivering a file delivery task to the target node through the designated source station.

According to the embodiments of the present disclosure, upon receipt of a task request for a file delivery task sent by a target node, it is determined whether there are other target nodes that have completed the file delivery task (i.e., it is determined whether there are completed nodes), a node is designated from the completed nodes as a source station corresponding to the task request. If there are completed nodes, a source server is designated as the source station corresponding to the task request. If there no completed nodes, a file delivery task is delivered to the target node according to the designated source station, so that the target node receives a file from the designated source station. As embodiments of the present disclosure can use a target node that has completed the file delivery task as a source station for other target nodes to pull a file, the load of the source server can be reduced, and stability of the source server can be improved. Moreover, by using the target nodes that have completed the file delivery task, the number of source stations may also increase accordingly, and the delivery speed thereof may also be increased. In addition, there may be a large number of target nodes that are widely distributed. Therefore, a completed node with a shorter route can be selected therefrom as a source station which many increase the delivery speed. In summary, embodiments of the present disclosure not only can reduce the load of the source server and improve stability of the source server but also can increase the file delivery speed.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show only some embodiments of the present disclosure, and a person skilled in the art may still derive other drawings from these accompanying drawings without creative efforts.

FIG. 1a is a schematic architectural diagram of a file delivery system according to an embodiment of the present disclosure;

FIG. 1b is a flowchart of a file delivery method according to an embodiment of the present disclosure;

FIG. 2 is another flowchart of a file delivery method according to an embodiment of the present disclosure;

FIG. 3a is a schematic diagram of a scenario of a file delivery method according to an embodiment of the present disclosure;

FIG. 3b is a further flowchart of a file delivery method according to an embodiment of the present disclosure;

FIG. 4a is a schematic structural diagram of a task management system according to an embodiment of the present disclosure;

FIG. 4b is another schematic structural diagram of a task management system according to an embodiment of the present disclosure; and

FIG. 5 is a schematic structural diagram of a file delivery apparatus according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person skilled in the art based on the embodiments of the present disclosure without creative efforts shall fall within the protection scope of the present disclosure.

The embodiments of the present disclosure provide a file delivery method, apparatus and system.

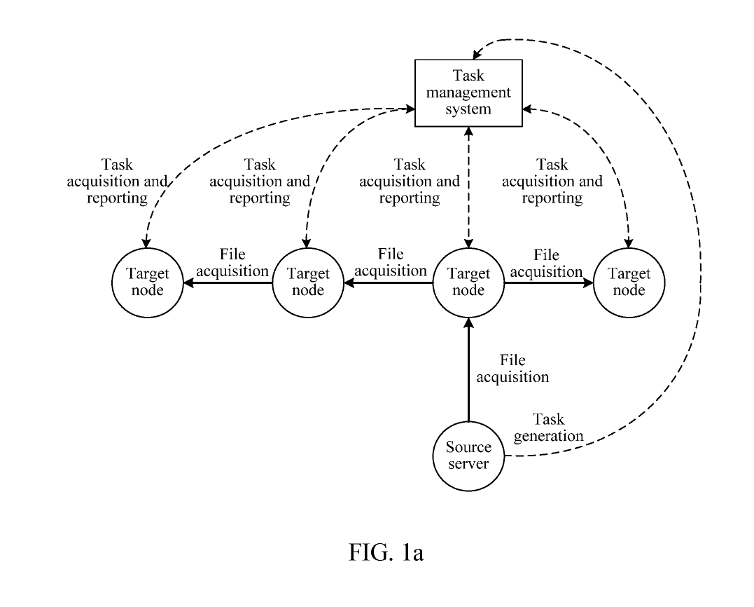

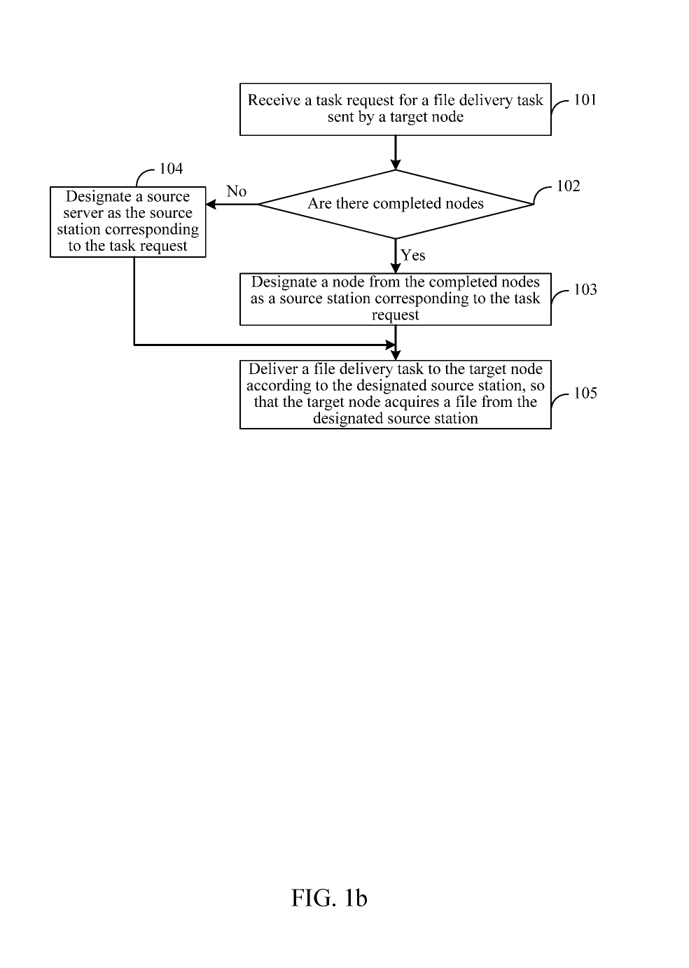

Referring to FIG. 1a, the file delivery system may include a task management system and a target node. A client is deployed on the target node. Any file delivery apparatus provided in the embodiments of the present disclosure is integrated in the client. In addition, the file delivery system may further include a source server. The source server may provide a file to be delivered.

When it is necessary to deliver a file, the task management system registers a file delivery task, and each target node may send a task request for a file delivery task to the task management system periodically. After receiving the task request, the task management system determines according to the task request whether there are other target nodes that have completed the file delivery task, i.e., completed nodes. The task management system may then designate a node from the completed nodes as a source station corresponding to the task requesting if there are completed nodes; and designate a source server as the source station corresponding to the task request if there are no completed nodes. The file management system may then send a file delivery task to the target node through the designated source station. The target node may receive a file from the designated source station, and upon completion of the task, report a result to the task management system. For example, referring to FIG. 1a, the dotted line indicates signaling interactions, and the solid line indicates transfer of file data.

Detailed descriptions are provided in the following respectively.

In this embodiment, the present disclosure is described from the perspective of a task management system. The task management system may be specifically integrated in a network device, such as a management server.

The present disclosure provides a file delivery method. The method includes receiving a task request for a file delivery task sent by a target node; determining according to the task request whether there are completed nodes, the completed nodes being other target nodes that have completed the file delivery task; designating, if there are completed nodes, a node from the completed nodes as a source station corresponding to the task request; designating, if there are no completed nodes, a source server as the source station corresponding to the task request; and delivering a file delivery task to the target node through the designated source station, so that the target node receives a file from the designated source station.

As shown in FIG. 1b, a specific process of the file delivery method may be as follows.

101. Receive a task request for a file delivery task sent by a target node.

For example, a file delivery task may be registered in a task management system. The corresponding task information may be acquired from a source server, such as information of files to be delivered, and then a file delivery task is generated according to the task information. Then, a target node sends a task request for a file delivery task to the task management system periodically, to acquire the file delivery task. For ease of description, in the embodiment of the present disclosure, a cycle of sending a task request is referred to as a task cycle, that is, block 101 may be specifically as follows.

Receive a task request for a file delivery task sent by a target node according to a task cycle.

The length of the task cycle may be set according to an actual application requirement, which is not further described herein.

102. Determine according to the task request whether there are completed nodes, perform block 103 if there are completed nodes, and perform block 104 if there are no completed nodes.

The completed nodes are other target nodes that have completed the file delivery task. For example, if target nodes A and B both have acquired a file indicated by the file delivery task from a source station, it indicates that the target nodes A and B have completed the file delivery task. Therefore, the target nodes A and B may be determined as completed nodes, and so on.

In some embodiments, the completed nodes may be added to the same set, for example, a completed node set. The completed node set may be implemented in many forms. For example, it is possible to add node identifications of the completed nodes to the completed node set, and then determine whether there are completed nodes by determining whether there are node identifications of the completed nodes in the completed node set; or it is also possible to add completed nodes to a list of target nodes and set a corresponding task completion state for each target node, if a target node has completed the file delivery task, the task completion state thereof is set as “completed”, and otherwise, if the target node has not completed the file delivery task, the task completion state thereof is set as “incomplete.” As such, whether there are completed nodes may be determined by determining task completion states in the list of target nodes, and so on.

103. Designate a node from the completed nodes as a source station corresponding to the task request if it is determined that there are completed nodes.

For example, it is possible to acquire attribute information and current load information of the completed nodes, and then select, according to the attribute information and the current load information, a node as a source station corresponding to the task request based on a selection strategy.

The selection strategy may be set according to an actual application requirement. For example, a node with the lightest load may be selected as the source station corresponding to the task request, a node with the fastest transfer speed may be selected as the source station corresponding to the task request, or a node at the shortest distance may be selected as the source station corresponding to the task request. Alternatively, a node with the strongest overall capacity may be selected as the source station corresponding to the task request. For example, weights may be distributed and set for parameters such as load, speed and distance, scores of nodes are calculate according to values and weights of the parameters. The task management system may then select a node with the highest score is selected, as the source station corresponding to the task request.

104. Designate a source server as the source station corresponding to the task request if it is determined that there are no completed nodes.

In some embodiments, to lighten the load of the source server, before the source server is designated as the source station corresponding to the task request, whether the target node is allowed to directly receive a file from the source server may be determined first. If so, the source server can be designated as the source station; and otherwise, it is necessary to instruct the source server to wait until next task cycle, that is, the target node may re-initiate a task request in the next task cycle. That is to say, before the block “designating a source server as the source station corresponding to the task request, the file delivery method may further include: determining whether the target node is allowed to receive a file from a source server; performing the block of designating a source server as the source station corresponding to the task request; or instructing the target node to wait until next task cycle.

105. Deliver a file delivery task to the target node through the designated source station, so that the target node receives a file from the designated source station.

For example, it is possible to acquire an address of the designated source station, for example, an Internet Protocol (IP) address of the source station, then generate a file delivery task carrying the address, and send the generated file delivery task to the target node, so that the target node receives a file from the corresponding source station according to the address.

After the file delivery task is delivered to the target node through the designated source station, a task execution result reported by the target node may be received. The target node is determined as a completed node if the task execution result indicates that file acquisition is successful, and the number of acquisition failures of the source station is increased if the task execution result indicates that file acquisition fails. For example, the number of acquisition failures of the source station may be increased by 1, and so on.

In some embodiments, before the number of acquisition failures of the source station is increased, failure reasons may be detected first. For example, the task management system may determine whether the source station is problematic or the target node is problematic or a link is problematic. If the source station is problematic, the number of acquisition failures of the source station is increased, and otherwise, re-downloading may be attempted, that is, a file is acquired from the source station again, and so on.

In some embodiments, if multiple nodes use a completed node as a source station and downloading fails, it may be considered that the completed node is deleted from candidate nodes (i.e., completed nodes) of the source station. That is, the file delivery method may further include deleting source stations, of which the number of acquisition failures exceeds a threshold, from the completed nodes.

The threshold may be set according to an actual application requirement, which is not further described herein.

It can be known from the above that, according to this embodiment, upon receipt of a task request for a file delivery task sent by a target node, it is determined whether there are other target nodes that have completed the file delivery task (i.e., it is determined whether there are completed nodes). A node is designated from the completed nodes as a source station corresponding to the task request if there are completed nodes. A source server is designated as the source station corresponding to the task request if there are no completed nodes. Then a file delivery task is delivered to the target node through the designated source station, so that the target node receives a file from the designated source station. Embodiments of the present disclosure use a target node that has completed the file delivery task as a source station for other target nodes to pull a file. The load of the source server can be reduced, and stability of the source server can be improved. Moreover, with more target nodes that have completed the file delivery task, the number of source stations may also increase accordingly, and the delivery speed thereof may also be increased. In addition, there may be a large number of target nodes, and the target nodes are widely distributed. Therefore, a completed node with a shorter route can be selected therefrom as a source station, which may increase the delivery speed. In summary, embodiments of the present disclosure not only can reduce the load of the source server and improve stability of the source server but also can increase the file delivery speed.

The following embodiment is described from the perspective of a file delivery apparatus. The file delivery apparatus may be integrated into a client, and the client may serve as a target node in this embodiment of the present disclosure.

The present disclosure provides a file delivery method, including: sending a task request for a file delivery task to a task management system; receiving the file delivery task returned by the task management system according to the task request; acquiring a file from a source station according to the file delivery task, and storing the file; and reporting to the task management system a task execution result indicating that file acquisition is successful, to serve as a source station for other target nodes to acquire files.

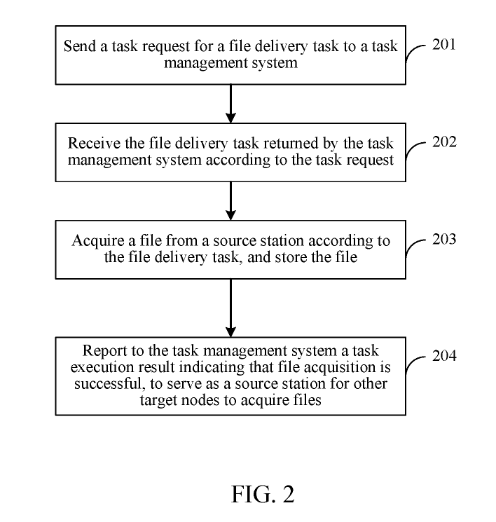

As shown in FIG. 2, a specific process of the file delivery method may be as follows.

201. Send a task request for a file delivery task to a task management system.

For example, a file delivery task may be registered in a task management system, and then a target node sends a task request for a file delivery task to the task management system periodically, to acquire the file delivery task. That is, block 201 may be specifically include sending a task request for a file delivery task to a task management system according to a task cycle.

The length of the task cycle may be set according to an actual application requirement, which is not further described herein.

202. Receive the file delivery task returned by the task management system according to the task request.

The file delivery task may carry an address of the source station, file storage information and other information.

In addition, reference may be made to Embodiment 1 for the specific operation of returning, by the task management system, a file delivery task according to the task request, which is not further described herein.

203. Receive a file from a source station according to the file delivery task, and store the file.

For example, it is possible to determine a corresponding source station according to the address of the source station, receive a file from the determined source station, and store the acquired file in a position indicated by the file storage information, and so on.

For example, by taking the target node being a client A as an example, if the source station is a client B, at this point, the client A may receive a file from the client B, and store the acquired file in a position indicated by the file storage information; if the source station is a source server, at this point, the client A may receive a file from the source server, and stores the acquired file in a position indicated by the file storage information, and so on.

204. Report to the task management system a task execution result indicating that file acquisition is successful, to serve as a source station for other target nodes to acquire files.

After the task management system receives the task execution result indicating that file acquisition is successful, sent by the target node, the target node can be determined as a completed node, to serve as a candidate node of the source station. If the target node is selected as a source station, file downloading may be provided for other target nodes. That is, in some embodiments, after the task execution result indicating that file acquisition is successful is reported to the task management system, the file delivery method may further include sending the stored file to the other target nodes upon receipt of a file acquisition request of the other target nodes.

In addition, it should be noted that a file execution result indicating that file acquisition fails may be reported to the task management system if acquisition of the file from the source station according to the file delivery task fails. As such, the task management system may perform further processing according to the task execution result. For example, the task management system may increase the number of acquisition failures of the source station by one. When the number of acquisition failures exceeds a threshold, the source station may be deleted from the completed nodes. Reference may be made to FIG. 1 for details, which are not further described herein.

It can be known from the above that, according to this embodiment, a target node sends a task request for a file delivery task to a task management system, to receive a file delivery task, and upon completion of the task, reports to the task management system a task execution result indicating that file acquisition is successful, to serve as a source station for other target nodes to acquire files. As embodiments of the present disclosure can use a target node that has completed the file delivery task as a source station for other target nodes to pull a file, the load of the source server can be reduced, and stability of the source server can be improved. Moreover, with increase of the target nodes that have completed the file delivery task, the number of source stations may also increase accordingly, and the delivery speed thereof may also be increased. In addition, there may be a large number of target nodes, and the target nodes are widely distributed. Therefore, a completed node with a shorter route can be selected therefrom as a source station, which may increase the delivery speed. In summary, embodiments of the present disclosure not only can reduce the load of the source server and improve stability of the source server but also can increase the file delivery speed.

The methods described according to FIGS. 1 and 2 are described in further detail below through examples.

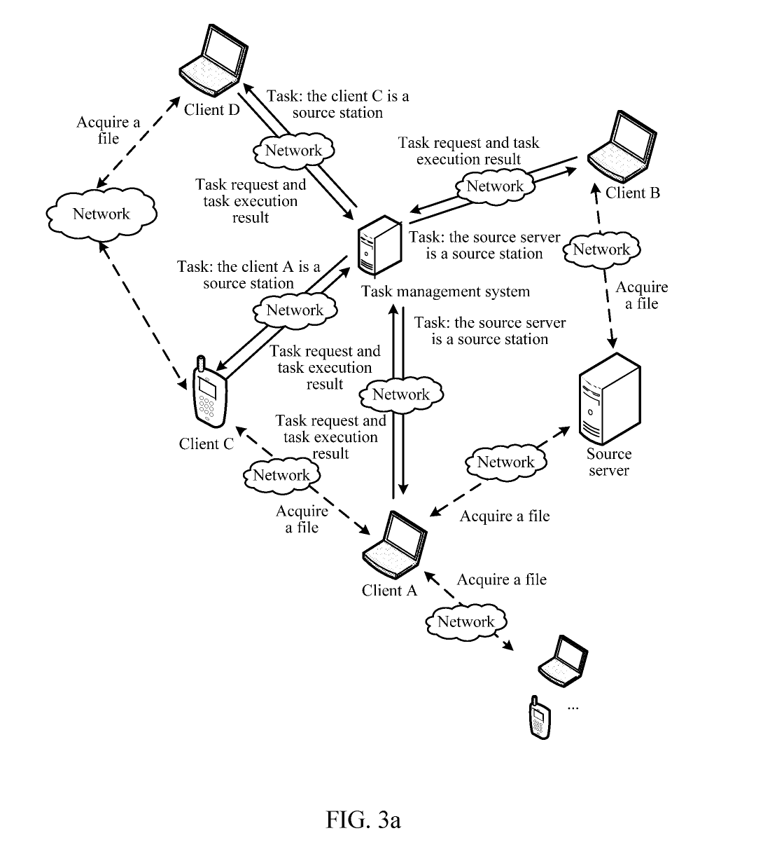

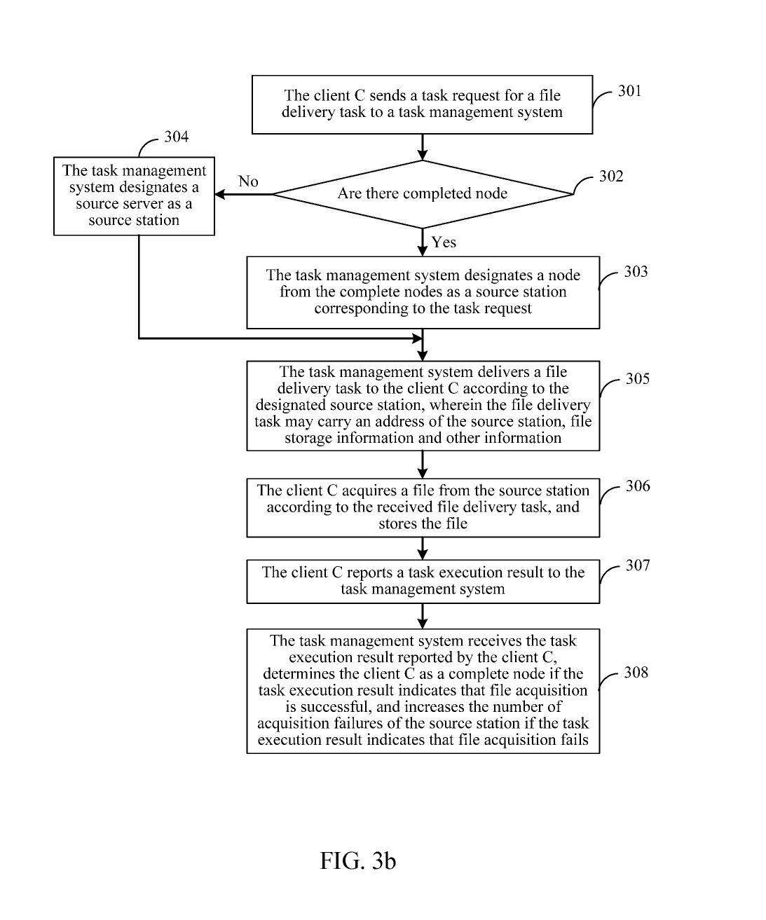

For example, referring to FIG. 3a, the file delivery system may include a task management system and a target node. A client is deployed on the target node. Any file delivery apparatus provided in the embodiments of the present disclosure is integrated in the client. In addition, the file delivery system may further include a source server. The source server may provide a file to be delivered.

For example, as shown in FIG. 3a, the client may include a client A, a client B, a client C, a client D and so on. When it is necessary to deliver files, the client A, the client B, the client C, the client D and so on send a task request for a file delivery task to a task management system. Upon receipt of the task request, the task management system determines according to the task request whether there are completed nodes. For example, upon receipt of the task requests of the client A and the client B, the task management system determines that there are no completed nodes. The task management system may then deliver a file delivery task to the client A and the client B respectively, and indicates in the task that the source station is a source server. In one example, the task may carry an address of the source server and the like. As such, the client A and the client B may acquire files from the source server. Afterwards, the client A and the client B may further report a task execution result to the task management system. If the task execution result indicates that file acquisition is successful, the task management system determines corresponding target nodes, for example, the client A and the client B, as completed nodes. As such, upon receipt of the task request of another client, for example, the client C, the task management system may select a node from the completed nodes, for example, the client A or the client B, as a source station. For example, the client A may be used as a source station for the client C to pull a file. Likewise, the client C may also report a task execution result to the task management system. If the task management system determines the client C is a completed node, the client C may serve as a candidate of the source station in a subsequent task request, for example, for the client D to pull a file, and so on.

Based on the above scenario, one process therein is described in detail below by taking the current target node being a client C as an example. As shown in FIG. 3b, a process of the file delivery method may include the following.

301. The client C sends a task request for a file delivery task to a task management system.

For example, the client C may send a task request for a file delivery task to a task management system according to a task cycle.

The length of the task cycle may be set according to an actual application requirement, which is not further described herein.

302. The task management system determines according to the task request whether there are completed nodes, block 303 is performed if there are completed nodes, and block 304 is performed if there are no completed nodes.

For example, in FIG. 3a, at this point, both the client A and the client B have successfully acquired a file indicated by the file delivery task from the source station. Therefore, the client A and the client B may be determined as completed nodes. At this point, block 303 may be executed, and otherwise, if no clients have successfully acquired a file, it is determined that there are no completed nodes, and then block 304 is performed.

303. The task management system designates, if determining that there are completed nodes, a node from the completed nodes as a source station corresponding to the task request.

For example, the task management system may acquire attribute information and current load information of the completed nodes, and then select, according to the attribute information and the current load information, a node as a source station corresponding to the task request based on a selection strategy.

The selection strategy may be set according to an actual application requirement. For example, a node with the lightest load may be selected as the source station corresponding to the task request, a node with the fastest transfer speed may be selected as the source station corresponding to the task request, or a node at the shortest distance may be selected as the source station corresponding to the task request. Alternatively, a node with the strongest overall capacity may be selected as the source station corresponding to the task request. For example, weights may be distributed and set for parameters such as load, speed and distance, scores of nodes are calculate according to values and weights of the parameters. The task management system may then select a node with the highest score as the source station corresponding to the task request. In this embodiment, suppose that the client A is selected as the source station corresponding to the task request.

304. When determining that there are no completed nodes, the task management system may determine whether the client C is allowed to directly receive a file from the source server. If so, the task management system may designate a source server as a source station; and otherwise, the task management system may instruct the client C to wait until next task cycle. That is, the client C may re-initiate a task request in the next task cycle.

305. The task management system delivers a file delivery task to the client C through the designated source station, wherein the file delivery task may carry an address of the source station, file storage information and other information.

In one embodiment, the task management system may acquire an address of the designated source station, for example, an IP address of the source station, then generates a file delivery task carrying the address, and sends the generated file delivery task to the client C.

In one embodiment, if the source station is determined as the client A, at this point, an IP address of the client A may be acquired, and then a file delivery task carrying the IP address of the client A is generated and delivered to the client C.

In one embodiment, if the source station is determined as a source server, at this point, an IP address of the source server may be acquired, and then a file delivery task carrying the IP address of the source server is generated and delivered to the client C, and so on.

306. The client C acquires a file from the source station according to the received file delivery task, and stores the file.

In one embodiment, if the source station is designated, in the received file delivery task, as the client A, the client C may find the client A according to the IP address of the client A, receive a file from the client A, and store the acquired file in a position indicated by the file storage information.

In one embodiment, if the source station is designated, in the received file delivery task, as a source server, the client C may find the source server according to the IP address of the source server, receive a file from the source server, and store the acquired file in a position indicated by the file storage information, and so on.

307. The client C reports a task execution result to the task management system.

308. The task management system receives the task execution result reported by the client C, determines the client C is a completed node if the task execution result indicates that file acquisition is successful, and increases the number of acquisition failures of the source station if the task execution result indicates that file acquisition fails, for example, if the source station is the client A, the number of acquisition failures of the client A may be increased by 1, and so on.

In some embodiments, before the number of acquisition failures of the source station is increased, failure reasons may be detected first. For example, whether the source station is problematic or the client C is problematic or a link is problematic may be detected, and so on. If the source station is problematic, the number of acquisition failures of the source station is increased, and otherwise, re-downloading may be attempted, that is, a file is acquired from the source station again, and so on.

In some embodiments, if multiple nodes use a completed node as a source station and the downloading fails, the task management system may delete the completed node from candidate nodes (i.e., completed nodes) of the source station. For example, if multiple nodes use the client A as a source station and the downloading fails, the task management system may delete client A from candidate nodes. For example, a file downloading state of the client A is changed from “completed” into “incomplete”, and the client A re-acquires a file, to keep the file correct. That is to say, a threshold may be set for the number of acquisition failures, and when the number of acquisition failures exceeds a threshold, the corresponding source station is deleted from the completed nodes. The threshold may be set according to an actual application requirement, which is not further described herein.

It should be understood that execution processes of other clients are similar to this, and are not further described herein.

It can be known from the above that, according to this embodiment, when receiving a task request for a file delivery task sent by a target node, a task management system may determine whether there are completed nodes; designate, if there are completed nodes, a node from the completed nodes as a source station corresponding to the task request; or otherwise, designate, if there are no completed nodes, a source server as the source station corresponding to the task request; and then deliver a file delivery task to the target node through the designated source station, so that the target node receives a file from the designated source station. As embodiments of the present disclosure can use a target node that has completed the file delivery task as a source station for other target nodes to pull a file. In embodiments of the present disclosure, the load of the source server can be reduced, and stability of the source server can be improved. Moreover, with increased use of the target nodes that have completed the file delivery task, the number of source stations may also increase accordingly, and the delivery speed thereof may also be increased. In addition, there may be a large number of target nodes, and the target nodes are widely distributed. Therefore, a completed node with a shorter route may be selected therefrom as a source station, which may increase the delivery speed. In summary, embodiments of the present disclosure not only can reduce the load of the source server and improve stability of the source server but also can increase the file delivery speed.

In one implementation, after embodiments of the present disclosure is applied to an actual production environment, the average time for delivering files may be decreased to about 19% of the original time, and the load of the source station may be decreased by about 80%.

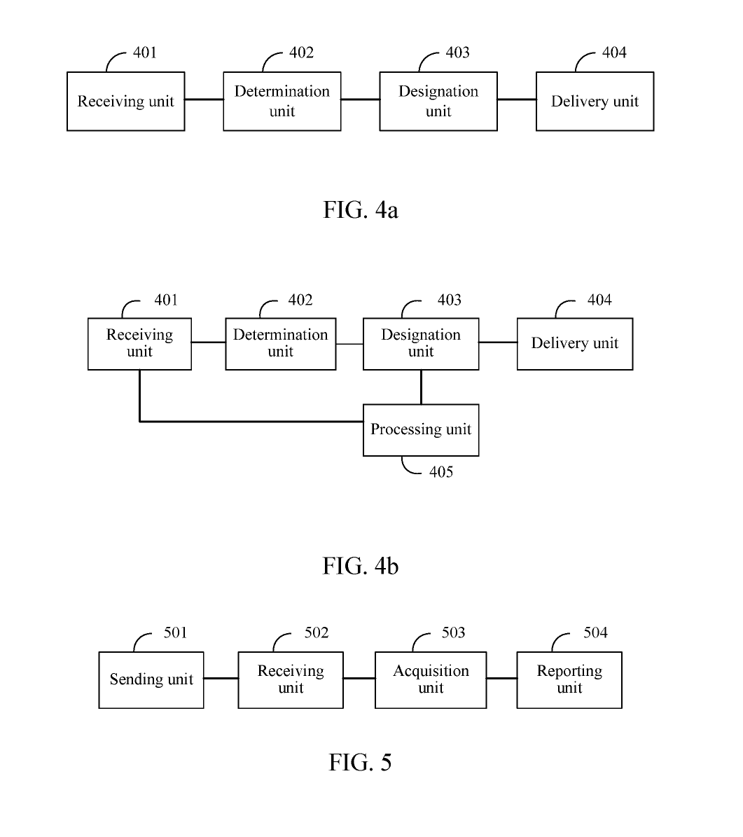

To better implement the above method, an embodiment of the present disclosure further provides a task management system. As shown in FIG. 4a, the task management system may include a receiving unit 401, a determination unit 402, a designation unit 403 and a delivery unit 404, as follows.

(1) Receiving unit 401. The receiving unit 401 may be configured to receive a task request for a file delivery task sent by a target node.

For example, the receiving unit 401 may be specifically configured to receive a task request for a file delivery task sent by a target node according to a task cycle.

The length of the task cycle may be set according to an actual application requirement, which is not further described herein.

(2) Determination unit 402. The determination unit 402 may be configured to determine according to the task request whether there are completed nodes.

The completed nodes are other target nodes that have completed the file delivery task. For example, if target nodes A and B both have acquired a file indicated by the file delivery task from a source station, it indicates that the target nodes A and B have completed the file delivery task. Therefore, the target nodes A and B may be determined as completed nodes, and so on.

In some embodiments, the completed nodes may be added to the same set, such as a completed node set. The completed node set may be implemented in many forms. For example, it is possible to add node identifications of the completed nodes to the completed node set, and then determine whether there are completed nodes by determining whether there are node identifications of the completed nodes in the completed node set; or it is also possible to add completed nodes to a list of target nodes and set a corresponding task completion state for each target node, if a target node has completed the file delivery task, the task completion state thereof is set as “completed”, and otherwise, if the target node has not completed the file delivery task, the task completion state thereof is set as “incomplete”, accordingly, whether there are completed nodes may be determined by determining task completion states in the list of target nodes, and so on.

(3) Designation unit 403. The designation unit 403 is configured to designate, if the determination unit 402 determines that there are completed nodes, a node from the completed nodes as a source station corresponding to the task request, and designate, if the determination unit 402 determines that there are no completed nodes, a source server as the source station corresponding to the task request.

For example, the designation unit 403 may be specifically configured to acquire, when the determination unit 402 determines that there are completed nodes, attribute information and current load information of the completed nodes, and select, according to the attribute information and the current load information, a node as a source station corresponding to the task request based on a strategy.

In some embodiments, to lighten the load of the source server, before the source server is designated as the source station corresponding to the task request, the task management system may first determine whether the target node is allowed to directly receive a file from the source server. If so, the source server can be designated as the source station; and otherwise, it is necessary to instruct the source server to wait until next task cycle. That is, the target node may re-initiate a task request in the next task cycle. In some embodiments, the designation unit 403 may be specifically configured to designate, when the determination unit 402 determines that there are no completed nodes, a source server as the source station corresponding to the task request if it is determined that the target node is allowed to receive a file from the source server, and instruct the target node to wait until next task cycle if the target node is allowed to receive a file from the source server.

(4) Delivery unit 404. The delivery unit 404 may be configured to deliver a file delivery task to the target node through the designated source station, so that the target node receives a file from the designated source station.

For example, the delivery unit 404 may include an acquisition sub-unit, a generation sub-unit and a sending sub-unit, as follows.

The acquisition sub-unit may be configured to acquire an address of the designated source station, for example, an IP address of the source station and the like.

The generation sub-unit may be configured to generate a file delivery task carrying the address.

The sending sub-unit may be configured to send the generated file delivery task to the target node, so that the target node receives a file from the corresponding source station according to the address.

After the file delivery task is delivered to the target node through the designated source station, a task execution result reported by the target node may be received, the target node is determined as a completed node if the task execution result indicates that file acquisition is successful, and the number of acquisition failures of the source station is increased if the task execution result indicates that file acquisition fails, for example, the number of acquisition failures of the source station may be increased by 1, and so on. That is, as shown in FIG. 4b, the task management system may further include a processing unit 405, as follows.

The receiving unit 405 may be further configured to receive a task execution result reported by the target node; and the processing unit 405 may be configured to determine the target node is a completed node if the task execution result indicates that file acquisition is successful; and increase the number of acquisition failures of the source station if the task execution result indicates that file acquisition fails.

In some embodiments, before the number of acquisition failures of the source station is increased, the processing unit 405 may first detect failure reasons, for example, the processing unit 405 may detect whether the source station is problematic or the target node is problematic or a link is problematic, and so on. If the source station is problematic, the number of acquisition failures of the source station is increased, and otherwise, re-downloading may be attempted, that is, a file is acquired from the source station again, and so on.

In some embodiments, if multiple nodes use a completed node as a source station and downloading fails, it may be considered that the completed node is deleted from candidate nodes (i.e., completed nodes) of the source station, that is:

the processing unit 405 may be further configured to delete source stations, of which the number of acquisition failures exceeds a threshold, from the completed nodes.

The task management system may be specifically integrated in a network device, such as a management server.

In some embodiments, the above units may be implemented as a same entity, and may also be implemented as the sameentity or several entities in any combination. Reference may be made to the foregoing method embodiments for specific implementation of the units, which are not further described herein.

It can be known from the above that, according to this embodiment, when a task management system receives a task request for a file delivery task sent by a target node, a determination unit 402 may determine whether there are other target nodes that have completed the file delivery task (i.e., determine whether there are completed nodes), if there are completed nodes, a designation unit 403 designates a node from the completed nodes as a source station corresponding to the task request, and if there are no completed nodes, designates a source server as the source station corresponding to the task request, and then a delivery unit 404 delivers a file delivery task to the target node through the designated source station, so that the target node receives a file from the designated source station. As embodiments of the present disclosure can use a target node that has completed the file delivery task as a source station for other target nodes to pull a file, the load of the source server can be reduced, and stability of the source server can be improved. Moreover, with increase of the target nodes that have completed the file delivery task, the number of source stations may also increase accordingly, and the delivery speed thereof may also be increased. In addition, there may be a large number of target nodes, and the target nodes are widely distributed. Therefore, a completed node with a shorter route can be selected therefrom as a source station, which can further increase the delivery speed. In summary, embodiments of the present disclosure not only can reduce the load of the source server and improve stability of the source server but also can increase the file delivery speed.

Correspondingly, an embodiment of the present disclosure further provides a file delivery apparatus. As shown in FIG. 5, the file delivery apparatus may include a sending unit 501, a receiving unit 502, an acquisition unit 503 and a reporting unit 504, as follows:

The sending unit 501 is configured to send a task request for a file delivery task to a task management system.

For example, the sending unit 501 may specifically send a task request for a file delivery task to a task management system according to a task cycle.

The length of the task cycle may be set according to an actual application requirement, which is not further described herein.

The receiving unit 502 is configured to receive the file delivery task returned by the task management system according to the task request.

The file delivery task may carry an address of the source station, file storage information and other information.

The acquisition unit 503 is configured to receive a file from a source station according to the file delivery task, and store the file.

For example, the acquisition unit 503 may be specifically configured to determine a corresponding source station according to the address of the source station, receive a file from the determined source station, and store the acquired file in a position indicated by the file storage information.

For example, if the source station is a client B, the acquisition unit 503 acquires a file from the client B, and stores the acquired file in a position indicated by the file storage information. If the source station is a source server, the acquisition unit 503 acquires a file from the source server, and stores the acquired file in a position indicated by the file storage information, and so on.

The reporting unit 504 is configured to report to the task management system a task execution result indicating that file acquisition is successful, to serve as a source station for other target nodes to acquire files.

After the task management system receives the task execution result indicating that file acquisition is successful sent by the target node, the target node can be determined as a completed node, to serve as a candidate node of the source station. If the target node is selected as a source station, file downloading may be provided for other target nodes.

The sending unit 501 may be further configured to send the stored file to the other target nodes upon receipt of a file acquisition request of the other target nodes.

In addition, it should be noted that, if the receiving unit 502 fails to receive a file from the source station according to the file delivery task, the reporting unit 504 may report to the task management system a file execution result indicating that file acquisition fails. The reporting unit 504 may be further configured to report to the task management system a file execution result indicating that file acquisition fails if acquisition of the file from the source station according to the file delivery task fails.

Accordingly, the task management system may perform further processing according to the task execution result. For example, the task management system may increase the number of acquisition failures of the source station, for example, by adding one. When the number of acquisition failures exceeds a threshold, the source station may be deleted from the completed nodes, and so on. Reference may be made to the foregoing embodiments for details, which are not further described herein.

The file delivery apparatus may be specifically integrated into a client, and the client may serve as a target node of this embodiment of the present disclosure.

In some embodiments, the above units may be implemented as a same entity, and may also be implemented as the same entity or several entities in any combination. Reference may be made to the foregoing method embodiments for specific implementation of the units, which are not further described herein.

It can be known from the above that, according to this embodiment, a sending unit 501 of the file delivery apparatus may send a task request for a file delivery task to a task management system, to receive a file delivery task, and after an acquisition unit 503 completes the task, a reporting unit 504 reports to the task management system a task execution result indicating that file acquisition is successful, to serve as a source station for other target nodes to acquire files. As embodiments of the present disclosure can use a target node that has completed the file delivery task as a source station for other target nodes to pull a file, with respect to embodiments of the present disclosure in the existing technology that files can only be directly pulled from the source server, the load of the source server can be reduced, and stability of the source server can be improved. Moreover, with more of the target nodes that have completed the file delivery task, the number of source stations may also increase accordingly, and the delivery speed thereof may also be increased. In addition, there may be a large number of target nodes, and the target nodes are widely distributed. Therefore, a completed node with a shorter route can be selected therefrom as a source station, which can increase the delivery speed. In summary, embodiments of the present disclosure not only can reduce the load of the source server and improve stability of the source server but also can increase the file delivery speed.

In addition, an embodiment of the present disclosure further provides a file delivery system, including any task management system and any file delivery apparatus according to the embodiments of the present disclosure. Reference may be specifically made to FIGS. 4a and 4b for the task management system, and reference may be specifically made to FIG. 5 for the file delivery apparatus. The task management system may be specifically integrated in a client, for example, by taking that the file delivery system includes a task management system and a client as an example, the file delivery system may be specifically as follows.

The task management system may be configured to receive a task request for a file delivery task sent by a target node; determine according to the task request whether there are completed nodes, the completed nodes being other target nodes that have completed the file delivery task; designate, if there are completed nodes, a node from the completed nodes as a source station corresponding to the task request; designate, if there are no completed nodes, a source server as the source station corresponding to the task request; and deliver a file delivery task to the target node through the designated source station, so that the target node receives a file from the designated source station.

The client may be configured to send a task request for a file delivery task to a task management system; receive the file delivery task returned by the task management system according to the task request; and receive a file from a source station according to the file delivery task, and store the file.

The client may be further configured to report to the task management system a task execution result indicating that file acquisition is successful, to serve as a source station for other target nodes to acquire files.

In this case, the task management system may be further configured to receive a task execution result reported by the client, determine the client is a completed node if the task execution result indicates that file acquisition is successful, and increase the number of acquisition failures of the source station if the task execution result indicates that file acquisition fails. For example, the number of acquisition failures of the source station may be increased by 1, and so on.

If the client is designated as a source station, a file acquisition request of other nodes may also be received. The client is further configured to send the stored file to the other target nodes upon receipt of a file acquisition request of the other target nodes.

In some embodiments, if multiple nodes use a completed node as a source station and downloading fails, it may be considered that the completed node is deleted from candidate nodes (i.e., completed nodes) of the source station. That is, the task management system may be further configured to delete source stations, of which the number of acquisition failures exceeds a threshold, from the completed nodes.

The present threshold may be set according to an actual application requirement, which is not further described herein.

In addition, the file delivery system may further include a source server. The source server is configured to provide a file to be delivered. For example, information of the file to be delivered may be sent to the task management system, the task management system registers a file delivery task according to the information of the file to be delivered, and then each target node (i.e., client) sends a task request periodically, and so on.

Reference may be made to the foregoing embodiments for specific implementation of the above devices, which are not further described herein.

As the file delivery system can include any task management system and any file delivery apparatus according to the embodiments of the present disclosure, the file delivery system can achieve beneficial effects that can be achieved by any task management system and any file delivery apparatus according to the embodiments of the present disclosure. Reference may be made to the foregoing embodiments for details thereof, which are not further described herein.

A person of ordinary skill in the art may understand that all or some of the blocks of the methods in the foregoing embodiments may be implemented by a program instructing relevant hardware. The program may be stored in a computer readable storage medium. The storage medium may be a Read Only Memory (ROM), a Random Access Memory (RAM), a magnetic disk, an optical disc, or the like.

The file delivery method, apparatus and system according to the embodiments of the present disclosure are described in detail above. The principle and implementation of the present disclosure are described herein through specific examples. The description about the embodiments is merely provided for ease of understanding of the method and core ideas of the present disclosure. Those of ordinary skill in the art can make changes to the present disclosure in terms of the specific implementations and application scopes according to the ideas of the present disclosure. Therefore, the content of the specification shall not be construed as limitations to the present disclosure.

What is claimed is:

1. A file delivery method, comprising:
receiving a task request for a file delivery task sent by a target node to request a file;
determining according to the task request whether there are completed nodes, the completed nodes being other target nodes that have completed a file delivery task delivering the file;
designating, if there are completed nodes, a node from the completed nodes as a source station corresponding to the task request;
designating, if there are no completed nodes, a source server as the source station corresponding to the task request; and
delivering the file to the target node through the designated source station.

2. The method according to claim 1, wherein delivering the file to the target node through the designated source station comprises:
acquiring an address of the designated source station;
generating a file delivery task carrying the address; and
sending the generated file delivery task to the target node.

3. The method according to claim 1, before the designating a source server as the source station corresponding to the task request, further comprising:
determining whether the target node is allowed to receive the file from a source server; and
designating a source server as the source station corresponding to the task request or instructing the target node to wait until next task cycle depending on whether the target node is allowed to receive the file from a source server.

4. The method according to claim 1, further comprising:
receiving a task execution result reported by the target node;
determining the target node as a completed node if the task execution result indicates that file acquisition is successful; and
increasing the number of acquisition failures of the source station if the task execution result indicates that file acquisition fails.

5. The method according to claim 4, further comprising:
deleting source stations from the completed nodes depending on whether the number of acquisition failures exceeds a threshold.

6. The method according to claim 1, wherein the designating a node from the completed nodes as a source station corresponding to the task request comprises:
acquiring attribute information and current load information of the completed nodes; and
selecting, according to the attribute information and the current load information, a node as a source station corresponding to the task request.

7. A file delivery method, comprising:
sending a task request for a file delivery task to a task management system;
receiving the file delivery task returned by the task management system according to the task request;
acquiring a file from a source station according to the file delivery task, and storing the file; and
reporting to the task management system a task execution result indicating that file acquisition is successful.

8. The method according to claim 7, after the reporting to the task management system a task execution result indicating that file acquisition is successful, further comprising:
sending the file to other target nodes upon receipt of a file acquisition request by the other target nodes.

9. The method according to claim 7, wherein the file delivery task carries an address of the source station and file storage information, and the acquiring a file from a source station according to the file delivery task, and storing the file further comprises:
determining a corresponding source station according to the address of the source station;
acquiring a file from the determined source station; and
storing the acquired file in a position indicated by the file storage information.

10. The method according to claim 7, the file delivery task returned by the task management system according to the task request, further comprising:
reporting to the task management system a task execution result indicating that file acquisition fails if acquisition of the file from the source station according to the file delivery task fails.

11. A task management and delivery system including a storage medium, storing a processor executable instruction therein, the processor executable instruction being used for performing the following operations, comprising:
receiving a task request for a file delivery task for delivering a file sent by a target node;
determining according to the task request whether there are completed nodes, the completed nodes being other target nodes that have completed a file delivery task delivering the file;
designating, if the determination unit determines that there are completed nodes, a node from the completed nodes as a source station corresponding to the task request, and designate, if the determination unit determines that there are no completed nodes, a source server as the source station corresponding to the task request; and
delivering a file delivery task to the target node through the designated source station.

12. The system according to claim 11, wherein the operations further comprise:
acquiring an address of the designated source station;
generating a file delivery task carrying the address; and
sending the generated file delivery task to the target node.

13. The system according to claim 11, wherein the operations further comprise:
designating, when the determination unit determines that there are no completed nodes, a source server as the source station corresponding to the task request if it is determined that the target node is allowed to receive a file from the source server, and instruct the target node to wait until next task cycle if the target node is allowed to receive a file from the source server.

14. The system according to claim 11, wherein the operations further comprise:
receiving a task execution result reported by the target node; and
determining the target node as a completed node if the task execution result indicates that file acquisition is successful; and increase the number of acquisition failures of the source station if the task execution result indicates that file acquisition fails.

15. The system according to claim 14, wherein the operations further comprise:
deleting source stations, of which the number of acquisition failures exceeds a threshold, from the completed nodes.

16. The system according to claim 11, wherein the operations further comprise:
acquiring when the determination unit determines that there are completed nodes, attribute information and current load information of the completed nodes, and select, according to the attribute information and the current load information, a node as a source station corresponding to the task request based on a strategy.

17. The system according to claim 11, further including a target system including a storage medium, storing a processor executable instruction therein, the processor executable instruction being used for performing the following operations, the target system operations comprising:
sending a task request for a file delivery task to a task management system;
receiving the file delivery task returned by the task management system according to the task request;
receiving a file from a source station according to the file delivery task, and store the file; and
reporting to the task management system a task execution result indicating that file acquisition is successful.

18. The system according to claim 17, the target system operations further comprising:
sending the stored file to the other target nodes upon receipt of a file acquisition request of the other target nodes.

19. The system according to claim 17, wherein the file delivery task carries an address of the source station and file storage information, and the target system operations further comprising:
determining a corresponding source station according to the address of the source station, receive a file from the determined source station, and store the acquired file in a position indicated by the file storage information.

20. The system according to any of claim 17, the target system operations further comprising:
reporting to the task management system a file execution result indicating that file acquisition fails if acquisition of the file from the source station according to the file delivery task fails.
